(19) United States
(12) Patent Application Publication
(10) Pub. No.: US 2019/0393514 A1
(43) Pub. Date: Dec. 26, 2019

(54) FUEL CELL SEPARATOR AND FUEL CELL STACK

(71) Applicant: HONDA MOTOR CO., LTD., Tokyo (JP)

(72) Inventors: Shuhei Goto, Wako-shi (JP); Yu Tomana, Wako-shi (JP); Akihito Giga, Wako-shi (JP)

(21) Appl. No.: 16/448,039

(22) Filed: Jun. 21, 2019

(30) Foreign Application Priority Data
Jun. 26, 2018 (JP) 2018-120592

(51) Int. Cl. H01M 8/026; H01M 8/1004; H01M 8/241; H01M 8/0206

(52) U.S. Cl. CPC H01M 8/026; H01M 8/0206; H01M 8/241; H01M 8/1004

(57) ABSTRACT

A cutout is formed in a passage bead of a first metal separator of a joint separator (fuel cell separator). The cutout connects an oxygen-containing gas flow field and an oxygen-containing gas supply passage. Channel forming ridges are provided in the cutout, integrally with the first metal separator. The channel forming ridges extend between the oxygen-containing gas supply passage and the oxygen-containing gas flow field. Connection channels connecting the oxygen-containing gas flow field and the oxygen-containing gas supply passage are formed on both sides of the channel forming ridges.

### CROSS-REFERENCE TO RELATED APPLICATION

This application is based upon and claims the benefit of priority from Japanese Patent Application No. 2018-120592 filed on Jun. 26, 2018, the contents of which are incorporated herein by reference.

### BACKGROUND OF THE INVENTION

### Field of the Invention

The present invention relates to a fuel cell separator and a fuel cell stack.

### Description of the Related Art

In general, a solid polymer electrolyte fuel cell employs a solid polymer electrolyte membrane. The solid polymer electrolyte membrane is a polymer ion exchange membrane. The fuel cell includes a membrane electrode assembly (MEA) formed by providing an anode on one surface of the solid polymer electrolyte membrane, and a cathode on the other surface of the solid polymer electrolyte membrane.

The membrane electrode assembly is sandwiched between separators (bipolar plates) to form a power generation cell (unit cell). In use, a predetermined number of power generation cells are stacked together to form an in-vehicle fuel cell stack, for example.

In each of the power generation cells, a fuel gas flow field is formed as one of reactant gas flow fields, between the MEA and one of separators, and an oxygen-containing gas flow field is formed as the other of reactant gas flow fields, between the MEA and the other of the separators.

Further, a plurality of reactant gas passages extend through the power generation cells in a stacking direction in which the power generation cells are stacked together.

In the power generation cells, as the separators, metal separators may be used. For example, in Japanese Laid-Open Patent Publication No. 2006-504872 (PCT), as seals for the metal separators, ridge shaped bead seals are formed by press forming. The bead seals around the reactant gas passages are provided with channels connecting the reactant gas passages and the reactant gas flow fields.

### SUMMARY OF THE INVENTION

The present invention has been made in relation to the above conventional technique, and an object of the present invention is to provide a fuel cell separator and a fuel cell stack which makes it possible to allow a reactant gas to flow smoothly between reactant gas passages and a reactant gas flow field.

According to a first aspect of the present invention, a fuel cell separator is provided. The fuel cell separator is formed by joining two metal separators together. Each of the metal separators has bead structure formed to protrude from one surface serving as a reaction surface. A reactant gas flow field as a passage of a reactant gas is formed on the one surface of the metal separator, the reactant gas being one of a fuel gas and an oxygen-containing gas. A reactant gas passage connected to the reactant gas flow field extends through the metal separators in a separator thickness direction. The bead structure includes a passage bead formed around the reactant gas passage. A cutout configured to connect the reactant gas flow field and the reactant gas passage is formed in the passage bead of one of the metal separators. A channel forming ridge extending between the reactant gas passage and the reactant gas flow field is provided in the cutout, integrally with one of the metal separators. Connection channels configured to connect the reactant gas flow field and the reactant gas passage are formed on both sides of the channel forming ridge, and the passage bead of the other of the metal separators includes a part extending in a direction intersecting with the channel forming ridge as viewed in the separator thickness direction.

According to a second aspect of the present invention, a fuel cell stack is provided. The fuel cell stack includes the fuel cell separator according to the first aspect of the invention and a membrane electrode assembly, and a plurality of the fuel cell separators and a plurality of the membrane electrode assemblies are stacked together alternately.

In the present invention, a cutout is formed by cutting out part of the passage bead of one of the metal separators.

A channel forming ridge extending between the reactant gas passage and the reactant gas flow field is provided in the cutout, and connection channels configured to connect the reactant gas flow field and the reactant gas passage are formed on both sides of the channel forming ridge. In the structure, the reactant gas can flow smoothly between the reactant gas passage and the reactant gas flow field.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an exploded perspective view showing a power generation cell;

FIG. 2 is a cross sectional view showing main components of a power generation cell taken along line II-II in FIG. 1;

FIG. 3 is a plan view showing a joint separator viewed from a side where a first metal separator is present;

FIG. 4 is a partial enlarged plan view showing the joint separator viewed from the side where the first metal separator is present;

FIG. 5 is a cross sectional view showing a power generation cell taken along line V-V in FIG. 4;

FIG. 6 is a cross sectional view showing the power generation cell taken along line VI-VI in FIG. 4; and

FIG. 7 is a plan view showing a joint separator viewed from a side where a second metal separator is present.

### DESCRIPTION OF THE PREFERRED EMBODIMENTS

Hereinafter, a preferred embodiment of a fuel cell separator and a fuel cell stack according to the present invention will be described with reference to the accompanying drawings.

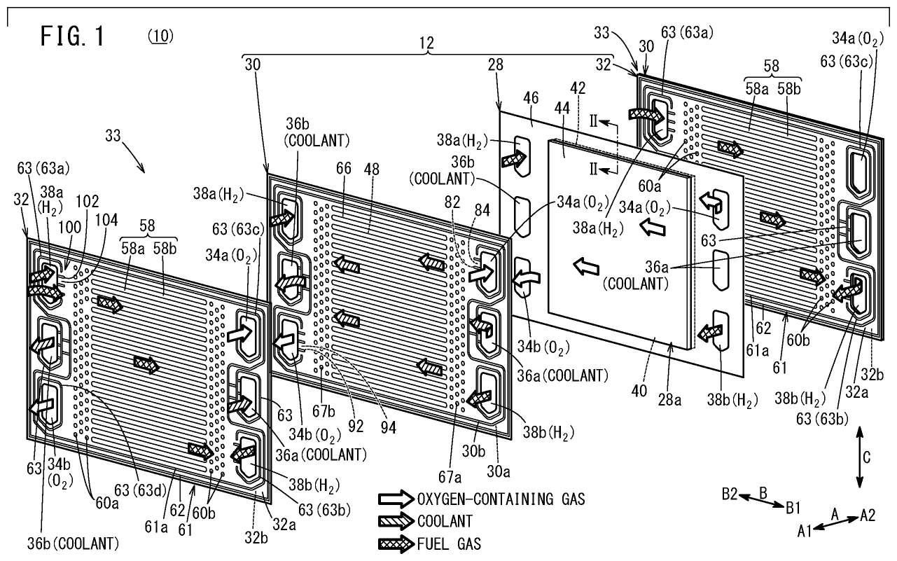

A power generation cell 12 as a unit of a fuel cell shown in FIG. 1 includes a resin film equipped MEA 28 having a resin film 46 in its outer periphery, a first metal separator 30 provided on one surface of the resin film equipped MEA 28 (in a direction indicated by an arrow A1), and a second metal separator 32 provided on the other surface of the resin film equipped MEA 28 (in a direction indicated by an arrow A2). A plurality of the power generation cells 12 are stacked together, e.g., in the direction indicated by the arrow A (horizontal direction) or in a direction indicated by an arrow C (gravity direction), and a tightening load (compression load) is applied to the power generation cells 12 in a stacking direction to form a fuel cell stack 10. For example, the fuel cell stack 10 is mounted as an in-vehicle fuel cell stack in a fuel cell electric vehicle (not shown).

For example, the first metal separator 30 and the second metal separator 32 are metal plates such as steel plates, stainless steel plates, aluminum plates, plated steel sheets, or metal plates having anti-corrosive surfaces by surface treatment. Each of the first metal separator 30 and the second metal separator 32 is formed by corrugating metal thin plates by press forming to have a corrugated shape in cross section and a wavy shape on the surface. The first metal separator 30 of one of the adjacent power generation cells 12 and the second metal separator 32 of the other of the adjacent power generation cells 12 are joined together to form a joint separator 33. The joint separator 33 is one form of a fuel cell separator.

At one end of the power generation cell 12 in a horizontal direction (long side direction) (at one end of the power generation cell 12 in a direction indicated by an arrow B1), an oxygen-containing gas supply passage 34a, a coolant supply passage 36a, and a fuel gas discharge passage 38b, which extend through the power generation cell 12 in the stacking direction indicated by the arrow A, are provided. The oxygen-containing gas supply passage 34a is one form of the reactant gas passage and the reactant gas supply passage. The fuel gas discharge passage 38b is one form of the reactant gas passage and the reactant gas discharge passage.

An oxygen-containing gas supply passage 34a, a coolant supply passage 36a, and a fuel gas discharge passage 38b are arranged in a vertical direction (indicated by an arrow C). An oxygen-containing gas is supplied through the oxygen-containing gas supply passage 34a. A coolant such as water is supplied through the coolant supply passage 36a. A fuel gas such as a hydrogen-containing gas is discharged through the fuel gas discharge passage 38b.

At the other end of the power generation cell 12 in the long side direction (at the other end of the power generation cell 12 in a direction indicated by an arrow B2), a fuel gas supply passage 38a, a coolant discharge passage 36b, and an oxygen-containing gas discharge passage 34b, which extend through the power generation cell 12 in the stacking direction, are provided. The fuel gas supply passage 38a is one form of the reactant gas passage and the reactant gas supply passage. The oxygen-containing gas discharge passage 34b is one form of the reactant gas passage and the reactant gas discharge passage.

The fuel gas supply passage 38a, the coolant discharge passage 36b, and the oxygen-containing gas discharge passage 34b are arranged in the vertical direction. The fuel gas is supplied through the fuel gas supply passage 38a. The coolant is discharged through the coolant discharge passage 36b. The oxygen-containing gas is discharged through the oxygen-containing gas discharge passage 34b. The layout of the oxygen-containing gas supply passage 34a, the oxygen-containing gas discharge passage 34b, the fuel gas supply passage 38a, and the fuel gas discharge passage 38b is not limited to the above embodiment, and may be changed as necessary depending on a required specification.

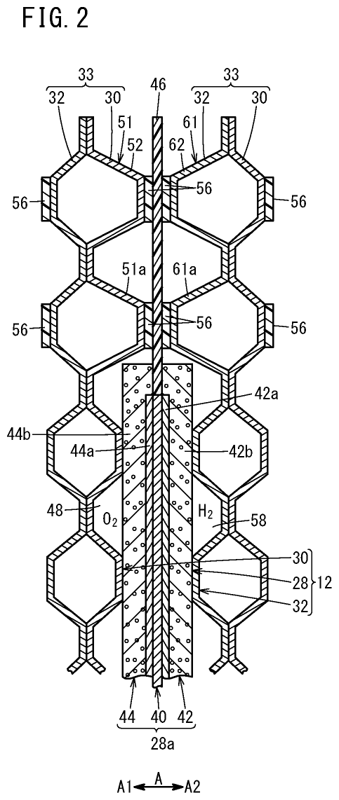

As shown in FIG. 2, the resin film equipped MEA 28 includes a membrane electrode assembly 28a, and a frame shaped resin film 46 provided in an outer peripheral portion of the membrane electrode assembly 28a. The membrane electrode assembly 28a includes an electrolyte membrane 40, and an anode 42 and a cathode 44 on both sides of the electrolyte membrane 40.

For example, the electrolyte membrane 40 includes a solid polymer electrolyte membrane (cation exchange membrane). For example, the solid polymer electrolyte membrane is a thin membrane of perfluorosulfonic acid containing water. The electrolyte membrane 40 is interposed between the anode 42 and the cathode 44. A fluorine based electrolyte may be used as the electrolyte membrane 40. Alternatively, an HC (hydrocarbon) based electrolyte may be used as the electrolyte membrane 40.

The cathode 44 includes a first electrode catalyst layer 44a joined to one surface of the electrolyte membrane 40, and a first gas diffusion layer 44b stacked on the first electrode catalyst layer 44a. The anode 42 includes a second electrode catalyst layer 42a joined to the other surface of the electrolyte membrane 40, and a second gas diffusion layer 42b stacked on the second electrode catalyst layer 42a.

The inner end surface of the resin film 46 is positioned close to, overlapped with, or in contact with the outer end surface of the electrolyte membrane 40. As shown in FIG. 1, at the end of the resin film 46 in the direction indicated by an arrow B1, the oxygen-containing gas supply passage 34a, the coolant supply passage 36a, and the fuel gas discharge passage 38b are provided. At the other end of the resin film 46 in a direction indicated by an arrow B2, the fuel gas supply passage 38a, the coolant discharge passage 36b, and the oxygen-containing gas discharge passage 34b are provided.

For example, the resin film 46 is made of PPS (polyphenylene sulfide), PPA (polyphthalamide), PEN (polyethylene naphthalate), PES (polyethersulfone), LCP (liquid crystal polymer), PVDF (polyvinylidene fluoride), a silicone resin, a fluororesin, m-PPE (modified polyphenylene ether resin), PET (polyethylene terephthalate), PBT (polybutylene terephthalate), or modified polyolefin. It should be noted that the electrolyte membrane 40 may be provided to protrude outward, without using the resin film 46. Further, the frame shaped film may be provided on both sides of the electrolyte membrane 40 which protrudes outward.

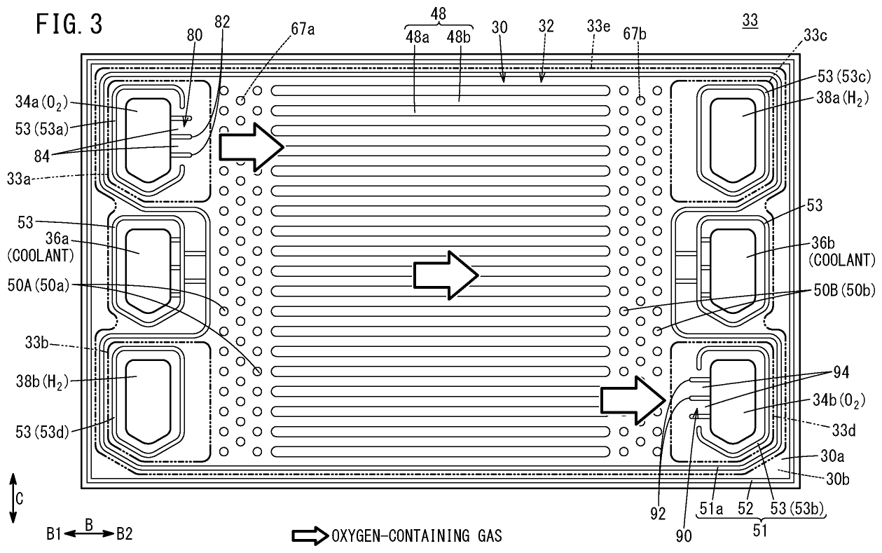

As shown in FIG. 3, the first metal separator 30 has an oxygen-containing gas flow field 48 on its surface 30a facing the resin film equipped MEA 28 of the first metal separator 30 (hereinafter referred to as the “surface 30a”). For example, the oxygen-containing gas flow field 48 extends in the direction indicated by the arrow B.

The oxygen-containing gas flow field 48 is connected to (in fluid communication with) the oxygen-containing gas supply passage 34a and the oxygen-containing gas discharge passage 34b. The oxygen-containing gas flow field 48 includes straight flow grooves 48b between a plurality of ridges 48a extending in the direction indicated by the arrow B. A plurality of wavy flow grooves may be provided instead of the plurality of straight flow groove 48b.

An inlet buffer 50A is provided on the surface 30a of the first metal separator 30, between the oxygen-containing gas supply passage 34a and the oxygen-containing gas flow field 48. A plurality of boss arrays each including a plurality of bosses 50a arranged in a direction indicated by an arrow C are formed in the inlet buffer 50A. Further, an outlet buffer 50B is provided on the surface 30a of the first metal separator 30 between the oxygen-containing gas discharge passage 34b and the oxygen-containing gas flow field 48. A plurality of boss arrays each including a plurality of bosses 50b are formed in the outlet buffer 50B. The bosses 50a, 50b protrude toward the resin film equipped MEA 28.

It should be noted that, on a surface 30b of the first metal separator 30, opposite to the oxygen-containing gas flow field 48, boss arrays each including a plurality of bosses 67a arranged in the direction indicated by the arrow C are provided between the boss arrays of the inlet buffer 50A, and boss arrays each including a plurality of bosses 67b arranged in the direction indicated by the arrow C are provided between the boss arrays of the outlet buffer 50B. The bosses 67a, 67b protrude in a direction opposite to the direction toward the resin film equipped MEA 28. The bosses 67a, 67b form a buffer on the coolant surface.

A first seal line 51 (bead structure) is formed on the surface 30a of the first metal separator 30 by press forming, so as to be expanded toward the resin film equipped MEA 28 (FIG. 1). As shown in FIG. 2, resin material 56 is fixed to protruding front surfaces of the first seal line 51 by printing, coating, etc. For example, polyester fiber is used as the resin material 56. Alternatively, the resin material 56 may be provided on the resin film 46. The resin material 56 is not essential, and may be dispensed with.

As shown in FIG. 3, the first seal line 51 includes a bead seal 51a (hereinafter referred to as the “inner bead 51a”) provided around the oxygen-containing gas flow field 48, the inlet buffer 50A, and the outlet buffer 50B, a bead seal 52 (hereinafter referred to as the “outer bead 52”) provided outside the inner bead 51a along the outer periphery of the first metal separator 30, and a plurality of bead seals 53 (hereinafter referred to as the “passage beads 53”) provided around the plurality of fluid passages (oxygen-containing gas supply passage 34a, etc.), respectively.

The outer bead 52 protrudes from the surface 30a of the first metal separator 30 toward the resin film equipped MEA 28, and is provided along the outer marginal portion of the surface 30a. The bead seals 51a, 52, 53 have seal structure where the bead seals 51a, 52, 53 tightly contact the resin film 46, and are deformed elastically by a tightening force in the stacking direction to seal gaps between the bead seals 51a, 52, 53 and the resin film 46 in an air tight and liquid tight manner.

The plurality of passage beads 53 protrude from the surface 30a of the first metal separator 30 toward the resin film equipped MEA 28, and surround the oxygen-containing gas supply passage 34a, the oxygen-containing gas discharge passage 34b, the fuel gas supply passage 38a, the fuel gas discharge passage 38b, the coolant supply passage 36a, and the coolant discharge passage 36b, respectively.

Hereinafter, among the plurality of passage beads 53, the passage bead formed around the oxygen-containing gas supply passage 34a will be referred to as the “passage bead 53a”, and the passage bead formed around the oxygen-containing gas discharge passage 34b will be referred to as the “passage bead 53b”.

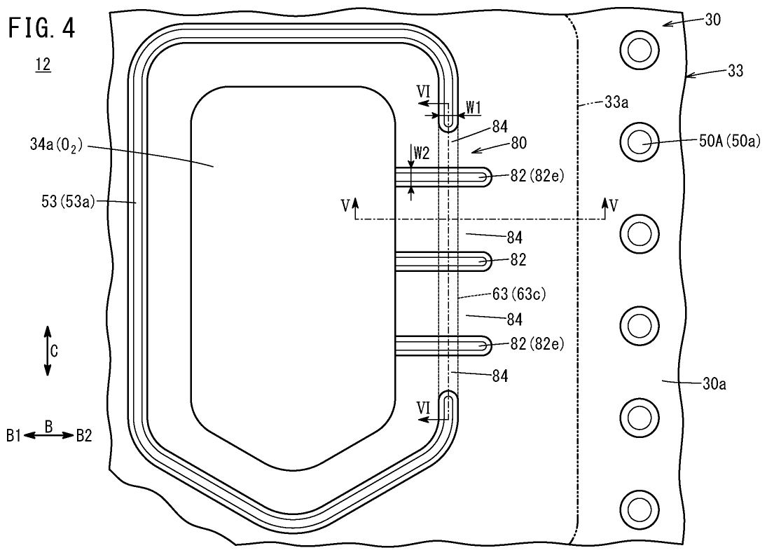

In the passage bead 53a surrounding the oxygen-containing gas supply passage 34a, a cutout 80 is provided on a side thereof adjacent to the oxygen-containing gas flow field 48, by cutting out part of the passage bead 53a. The cutout 80 connects the oxygen-containing gas supply passage 34a and the oxygen-containing gas flow field 48. As shown in FIG. 4, a plurality of channel forming ridges 82 are provided in the cutout 80, integrally with the first metal separator 30. The channel forming ridges 82 extend between the oxygen-containing gas supply passage 34a and the oxygen-containing gas flow field 48. Specifically, the plurality of channel forming ridges 82 are formed so as to be expanded toward the resin film equipped MEA 28 (FIG. 1) by press forming. The plurality of channel forming ridges 82 extend in parallel to each other. Only one channel forming ridge 82 may be provided.

Connection channels 84 are formed between the plurality of channel forming ridges 82 for thereby connecting the oxygen-containing gas supply passage 34a and the oxygen-containing gas flow field 48. The connection channels 84 are provided on both sides of the channel forming ridges 82. The connection channels 84 are formed between channel forming ridges 82e that are positioned at both ends of the plurality of channel forming ridges 82, and both ends of the passage bead 53a.

The width W2 of each of the plurality of channel forming ridges 82 (dimension in a direction perpendicular to a direction in which the channel forming ridges 82 extend) is the same as the width W1 of the passage bead 53a (dimension in a direction perpendicular to a direction in which the passage bead 53a extends). The width W2 of the channel forming ridges 82 may be smaller, or larger than the width W1 of the passage bead 53a. The length by which the plurality of channel forming ridges 82 extend is larger than the width W1 of the passage bead 53a. The plurality of channel forming ridges 82 extend from the cutout 80 toward the reactant gas flow field (oxygen-containing gas flow field 48) and the reactant gas passage (oxygen-containing gas supply passage 34a).

The plurality of channel forming ridges 82 extend in a direction intersecting with (perpendicular to) a passage bead 63c, described later, of the second metal separator 32 as viewed in a separator thickness direction.

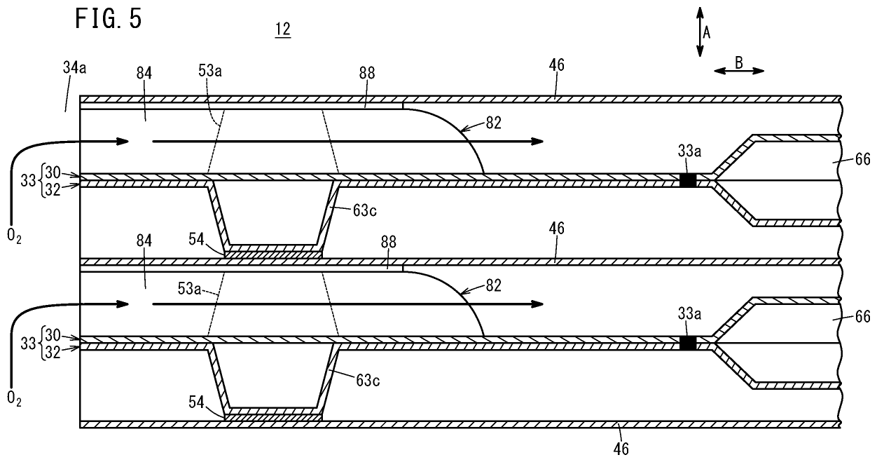

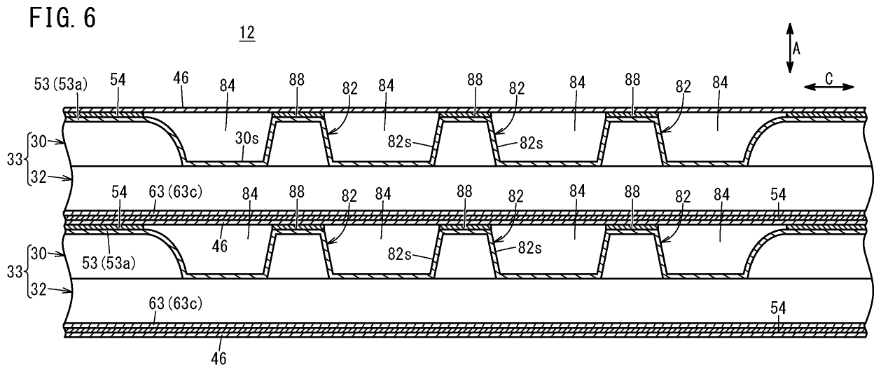

As shown in FIGS. 5 and 6, a resin material 88 is provided at each of top parts of the plurality of channel forming ridges 82. The thickness and the material of the resin material 88 are the same as those of the resin material 54 provided at the top part of the passage bead 53a (first seal line 51).

As shown in FIG. 6, the protruding height of the channel forming ridges 82 (from a base plate part 30s) is the same as the protruding height of the passage bead 53a (from the base plate part 30s). In the embodiment of the present invention, the side wall 82s of the channel forming ridge 82 is inclined from the separator thickness direction (indicated by the arrow A). Therefore, each of the channel forming ridges 82 has a trapezoidal shape in cross section in the separator thickness direction. It should be noted that the cross sectional shape of the channel forming ridges 82 in the separator thickness direction may have a rectangular shape.

In FIG. 3, in the passage bead 53b surrounding the oxygen-containing gas discharge passage 34b, a cutout 90 is provided on a side thereof adjacent to the oxygen-containing gas flow field 48, by cutting out part of the passage bead 53b. The cutout 90 connects the oxygen-containing gas discharge passage 34b and the oxygen-containing gas flow field 48. A plurality of channel forming ridges 92 are provided in the cutout 90, integrally with the first metal separator 30. The channel forming ridges 92 extend between the oxygen-containing gas discharge passage 34b and the oxygen-containing gas flow field 48. Only one channel forming ridge 92 may be provided.

Connection channels 94 are formed between the plurality of channel forming ridges 92 for thereby connecting the oxygen-containing gas discharge passage 34b and the oxygen-containing gas flow field 48. The connection channels 94 are provided on both sides of the channel forming ridges 92. The passage bead 53b, the channel forming ridges 92, and the connection channels 94 provided adjacent to the oxygen-containing gas discharge passage 34b have the same structure as the passage bead 53a, the plurality of channel forming ridges 82, and the connection channels 84 provided adjacent to the oxygen-containing gas supply passage 34a, and thus, the detailed description thereof is omitted.

The passage bead 53c around the fuel gas supply passage 38a of the first metal separator 30 faces the passage bead 63a of the second metal separator 32 described later through the resin film 46. The passage bead 53d around the fuel gas discharge passage 38b of the first metal separator 30 faces the passage bead 63b of the second metal separator 32 described later through the resin film 46.

As shown in FIG. 3, the first metal separator 30 and the second metal separator 32 of the joint separator 33 are joined together by laser welding lines 33a to 33e. The laser welding lines 33a to 33e are one form of a joint portion joining the first metal separator 30 and the second metal separator 32 together. The laser welding line 33a is formed around the oxygen-containing gas supply passage 34a, the passage bead 53a, and the plurality of channel forming ridges 82. The laser welding line 33b is formed around the fuel gas discharge passage 38b and the passage bead 53d.

The laser welding line 33c is formed around the fuel gas supply passage 38a and the passage bead 53c. The laser welding line 33d is formed around the oxygen-containing gas discharge passage 34b, the passage bead 53b, and the plurality of channel forming ridges 92. The laser welding line 33e is formed along the entire outer peripheral portion of the joint separator 33 around the oxygen-containing gas flow field 48, the oxygen-containing gas supply passage 34a, the oxygen-containing gas discharge passage 34b, the fuel gas supply passage 38a, the fuel gas discharge passage 38b, the coolant supply passage 36a, and the coolant discharge passage 36b.

It should be noted that the first metal separator 30 and the second metal separator 32 may be joined together by brazing, instead of laser welding.

As shown in FIG. 1, the second metal separator 32 has a fuel gas flow field 58 on its surface 32a facing the resin film equipped MEA 28 (hereinafter referred to as the “surface 32a”). For example, the fuel gas flow field 58 extends in the direction indicated by the arrow B.

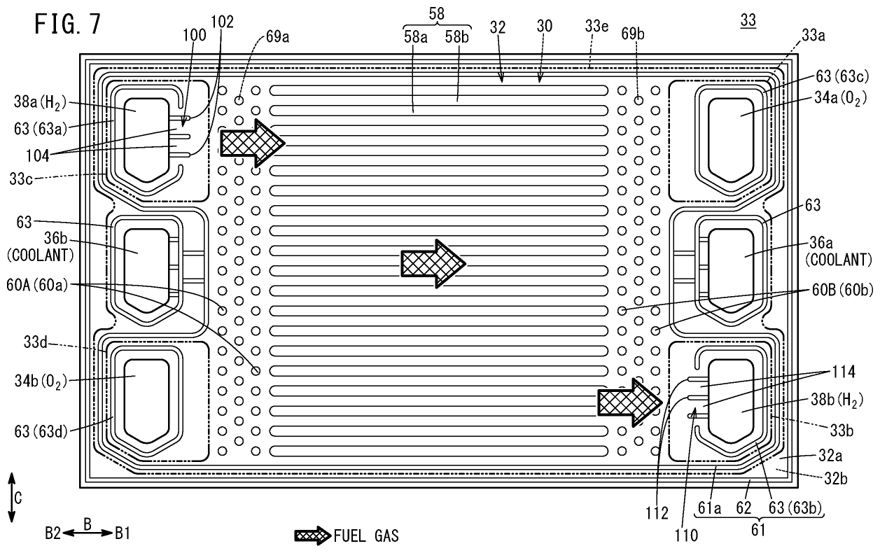

As shown in FIG. 7, the fuel gas flow field 58 is connected to (in fluid communication with) the fuel gas supply passage 38a and the fuel gas discharge passage 38b.

The fuel gas flow field 58 includes straight flow grooves 58b between a plurality of ridges 58a extending in the direction indicated by the arrow B. A plurality of wavy flow grooves may be provided instead of the plurality of straight flow groove 58b.

An inlet buffer 60A is provided on the surface 32a of the second metal separator 32, between the fuel gas supply passage 38a and the fuel gas flow field 58. A plurality of boss arrays each including a plurality of bosses 60a arranged in the direction indicated by the arrow C are formed in the inlet buffer 60A. Further, an outlet buffer 60B is provided on the surface 32a of the second metal separator 32 between the fuel gas discharge passage 38b and the fuel gas flow field 58. A plurality of boss arrays each including a plurality of bosses 60b are formed in the outlet buffer 60B. The bosses 60a, 60b protrude toward the resin film equipped MEA 28.

It should be noted that, on a surface 32b of the second metal separator 32, opposite to the fuel gas flow field 58, boss arrays each including a plurality of bosses 69a arranged in the direction indicated by the arrow C are provided between the boss arrays of the inlet buffer 60A, and boss arrays each including a plurality of bosses 69b arranged in the direction indicated by the arrow C are provided between the boss arrays of the outlet buffer 60B. The bosses 69a, 69b protrude in a direction opposite to the direction toward the resin film equipped MEA 28. The bosses 69a, 69b form a buffer on the coolant surface.

A second seal line 61 (bead structure) is formed on the surface 32a of the second metal separator 32 so as to be expanded toward the resin film equipped MEA 28 by press forming.

As shown in FIG. 2, a resin material 56 is fixed to protruding front surfaces of the second seal line 61 by printing, coating, etc. For example, polyester fiber is used as the resin material 56. The resin material 56 may be provided on the resin film 46. The resin material 56 is not essential, and thus may be dispensed with.

As shown in FIG. 7, the second seal line 61 includes a bead seal (hereinafter referred to as the “inner bead 61a”) provided around the fuel gas flow field 58, the inlet buffer 60A and the outlet buffer 60B, a bead seal (hereinafter referred to as the “outer bead 62”) provided outside the inner bead 61a along the outer periphery of the second metal separator 32, and a plurality of bead seals (hereinafter referred to as the “passage beads 63”) provided around the plurality of fluid passages (fuel gas supply passage 38a, etc.), respectively. The outer bead 62 protrudes from the surface 32a of the second metal separator 32, and is provided along the outer marginal portion of the surface 32a.

The plurality of passage beads 63 protrude from the surface 32a of the second metal separator 32, and are provided around the oxygen-containing gas supply passage 34a, the oxygen-containing gas discharge passage 34b, the fuel gas supply passage 38a, the fuel gas discharge passage 38b, the coolant supply passage 36a, and the coolant discharge passage 36b, respectively.

In the passage bead 63a surrounding the fuel gas supply passage 38a, a cutout 100 is provided on a side thereof adjacent to the fuel gas flow field 58, by cutting out part of the passage bead 63a. The cutout 100 connects the fuel gas supply passage 38a and the fuel gas flow field 58. A plurality of channel forming ridges 102 are provided in the cutout 100, integrally with the second metal separator 32.

The channel forming ridges 102 extend between the fuel gas supply passage 38a and the fuel gas flow field 58. Connection channels 104 are formed between the plurality of channel forming ridges 102 for thereby connecting the fuel gas supply passage 38a and the fuel gas flow field 58. Only one channel forming ridge 102 may be provided, and the connection channels 104 may be provided on both sides of the channel forming ridge 102.

In the passage bead 63b surrounding the fuel gas discharge passage 38b, a cutout 110 is provided on a side thereof adjacent to the fuel gas flow field 58, by cutting out part of the passage bead 63b. The cutout 110 connects the fuel gas discharge passage 38b and the fuel gas flow field 58. A plurality of channel forming ridges 112 are provided in the cutout 110, integrally with the second metal separator 32. The channel forming ridges 112 extend between the fuel gas discharge passage 38b and the fuel gas flow field 58. Connection channels 114 are formed between the plurality of channel forming ridges 112 for thereby connecting the fuel gas discharge passage 38b and the fuel gas flow field 58. Only one channel forming ridge 112 may be provided, and the connection channels 114 may be provided on both sides of the channel forming ridge 112.

The passage bead 63a, the plurality of channel forming ridges 102, and the connection channels 104 provided adjacent to the fuel gas supply passage 38a of the second metal separator 32 have the same structure as the passage bead 53a, the plurality of channel forming ridges 82, and the connection channels 84 (FIG. 4) provided adjacent to the oxygen-containing gas supply passage 34a of the first metal separator 30, respectively, and thus, the detailed description thereof is omitted. Further, the passage bead 63b, the plurality of channel forming ridges 112, and the connection channels 114 provided adjacent to the fuel gas discharge passage 38b of the second metal separator 32 have the same structure as the passage bead 53a, the plurality of channel forming ridges 82, and the connection channels 84 (FIG. 4) provided adjacent to the oxygen-containing gas supply passage 34a of the first metal separator 30, respectively, and thus, the detailed description thereof is omitted.

The passage bead 63c of the second metal separator 32 around the oxygen-containing gas supply passage 34a faces the passage bead 53a (FIG. 3) of the first metal separator 30 through the resin film 46. As shown in FIG. 4, as viewed in the separator thickness direction, the passage bead 63c of the second metal separator 32 includes a part extending in a direction intersecting with the plurality of channel forming ridges 82 provided in the first metal separator 30. In FIG. 7, the passage bead 63d around the oxygen-containing gas discharge passage 34b of the second metal separator 32 faces the passage bead 53b (FIG. 3) of the first metal separator 30 through the resin film 46.

As shown in FIG. 1, a coolant flow field 66 is formed between the surface 30b of the first metal separator 30 and the surface 32b of the second metal separator 32 that are joined together. The coolant flow field 66 is connected to (in fluid communication with) the coolant supply passage 36a and the coolant discharge passage 36b. The coolant flow field 66 is formed between the back surface of the oxygen-containing gas flow field 48 of the first metal separator 30 and the back surface of the fuel gas flow field 58 of the second metal separator 32 when the first metal separator 30 and the second metal separator 32 are overlapped with each other.

Operation of the power generation cell 12 having the above structure will be described below.

Firstly, as shown in FIG. 1, an oxygen-containing gas such as the air is supplied to the oxygen-containing gas supply passage 34a. A fuel gas such as a hydrogen-containing gas is supplied to the fuel gas supply passage 38a. A coolant such as pure water, ethylene glycol, or oil is supplied to the coolant supply passages 36a.

As shown in FIGS. 3 and 5, the oxygen-containing gas flows from the oxygen-containing gas supply passage 34a into the oxygen-containing gas flow field 48 of the first metal separator 30 through the connection channels 84 formed between the plurality of channel forming ridges 82. Then, as shown in FIG. 1, the oxygen-containing gas moves along the oxygen-containing gas flow field 48 in the direction indicated by the arrow B, and the oxygen-containing gas is supplied to the cathode 44 of the membrane electrode assembly 28a.

In the meanwhile, as shown in FIG. 7, the fuel gas flows from the fuel gas supply passage 38a into the fuel gas flow field 58 of the second metal separator 32 through the connection channels 104 formed between the plurality of channel forming ridges 102. The fuel gas flows along the fuel gas flow field 58 in the direction indicated by the arrow B, and then, the fuel gas is supplied to the anode 42 of the membrane electrode assembly 28a.

Thus, in each of the membrane electrode assemblies 28a, the oxygen-containing gas supplied to the cathode 44 and the fuel gas supplied to the anode 42 are consumed in electrochemical reactions in the first electrode catalyst layer 44a and the second electrode catalyst layer 42a for generating electricity.

Then, after the oxygen-containing gas supplied to the cathode 44 is consumed at the cathode 44, the oxygen-containing gas flows from the oxygen-containing gas flow field 48 into the oxygen-containing gas discharge passage 34b through the connection channels 94 formed between the plurality of channel forming ridges 92, and the oxygen-containing gas is discharged along the oxygen-containing gas discharge passage 34b in the direction indicated by the arrow A. Likewise, after the fuel gas supplied to the anode 42 is consumed at the anode 42, the fuel gas flows from the fuel gas flow field 58 into the fuel gas discharge passage 38b through the connection channels 114 (FIG. 7) formed between the plurality of channel forming ridges 112. Then, the fuel gas flows along the fuel gas discharge passage 38b in the direction indicated by the arrow A.

Further, the coolant supplied to the coolant supply passage 36a flows into the coolant flow field 66 formed between the first metal separator 30 and the second metal separator 32, and then flows in the direction indicated by the arrow B. After the coolant cools the membrane electrode assembly 28a, the coolant is discharged from the coolant discharge passage 36b.

The embodiment of the present invention offers the following advantages.

In the joint separator 33 and the fuel cell stack 10, the channel forming ridges extending between the reactant gas passage and the reactant gas flow field are provided in the cutout formed by cutting out part of the passage bead of one of the metal separators, and connection channels are formed on both sides of the channel forming ridges. In the structure, the reactant gas can flow smoothly between the reactant gas passage and the reactant gas flow field. That is, in comparison with the case of adopting a structure where tunnels intersecting with the passage bead are formed in the passage bead as a channel connecting the reactant gas passage and the reactant gas flow field, whereby the reactant gas flows between the front side and the back side of one of the metal separators, the structure of the embodiment of the present invention has no bents (steps) in the channels, or smaller bents (steps) in the channels, since the reactant gas flows through only the front side of the metal separator. Therefore, the reactant gas can flow smoothly the connection channels.

Specifically, the channel forming ridges 82, 92 extending between the oxygen-containing gas supply passage 34a and the oxygen-containing gas flow field 48, and between the oxygen-containing gas discharge passage 34b and the oxygen-containing gas flow field 48 are formed in the cutouts 80, 90 formed by cutting out parts of the passage beads 53a, 53b of the first metal separator 30, and the connection channels 84, 94 are formed on both sides of the channel forming ridges 82, 92. In the structure, the oxygen-containing gas can flow smoothly between the oxygen-containing gas supply passage 34a and the oxygen-containing gas flow field 48, and between the oxygen-containing gas flow field 48 and the oxygen-containing gas discharge passage 34b.

Further, the channel forming ridges 102, 112 extending between the fuel gas supply passage 38a and the fuel gas flow field 58, and between the fuel gas flow field 58 and the fuel gas discharge passage 38b are formed in the cutouts 100, 110 by cutting out parts of the passage beads 63a, 63b of the second metal separator 32, and the connection channels 104, 114 are formed on both sides of the channel forming ridges 102, 112. In the structure, the fuel gas can flow smoothly between the fuel gas supply passage 38a and the fuel gas flow field 58, and between the fuel gas discharge passage 38b and the fuel gas flow field 58.

The protruding heights of the channel forming ridges 82, 92, 102, 112 are the same as the protruding heights of the passage beads 53a, 53b, 63a, 63b. In the structure, also in the cutouts 80, 90, 100, 110, it is possible to suitably support the member (resin film 46) sandwiched between the fuel cell separators (joint separators 33) of the fuel cell stack 10.

The present invention is not limited to the above described embodiments. Various modifications can be made without departing from the gist of the present invention.

What is claimed is:

1. A fuel cell separator formed by joining two metal separators together, the metal separators each having bead structure formed to protrude from one surface serving as a reaction surface, wherein a reactant gas flow field as a passage of a reactant gas is formed on the one surface of the metal separator, the reactant gas being one of a fuel gas and an oxygen-containing gas; a reactant gas passage connected to the reactant gas flow field extends through the metal separators in a separator thickness direction; and the bead structure includes a passage bead formed around the reactant gas passage,
wherein a cutout configured to connect the reactant gas flow field and the reactant gas passage is formed in the passage bead of one of the metal separators;
a channel forming ridge extending between the reactant gas passage and the reactant gas flow field is provided in the cutout, integrally with one of the metal separators;
connection channels configured to connect the reactant gas flow field and the reactant gas passage are formed on both sides of the channel forming ridge; and
the passage bead of another of the metal separators includes a part extending in a direction intersecting with the channel forming ridge as viewed in the separator thickness direction.

2. The fuel cell separator according to claim 1, wherein a protruding height of the channel forming ridge is same as a protruding height of the passage bead.

3. The fuel cell separator according to claim 1, wherein a width of the channel forming ridge is same as a width of the passage bead.

4. The fuel cell separator according to claim 1, wherein a top part of the channel forming ridge is provided with resin material.

5. The fuel cell separator according to claim 1, wherein a joint portion configured to join the two metal separators is provided around the passage bead and the channel forming ridge.

6. The fuel cell separator according to claim 1, wherein a coolant flow field configured to allow a coolant to flow is formed between the two metal separators.

7. The fuel cell separator according to claim 1, wherein a length in which the channel forming ridge extends is larger than a width of the passage bead.

8. The fuel cell separator according to claim 1, wherein the channel forming ridge protrudes from the cutout toward the reactant gas flow field and the reactant gas passage.

9. The fuel cell separator according to claim 1, wherein the channel forming ridge extends in a direction perpendicular to the passage bead of the other of the metal separators as viewed in the separator thickness direction.

10. The fuel cell separator according to claim 1, wherein the connection channels are provided respectively at a position between a reactant gas supply passage configured to supply the reactant gas and the reactant gas flow field, and a position between a reactant gas discharge passage configured to discharge the reactant gas and the reactant gas flow field.

11. The fuel cell separator according to claim 1, wherein the channel forming ridge comprises a plurality of channel forming ridges.

12. The fuel cell separator according to claim 11, wherein the plurality of channel forming ridges extend in parallel to each other.

13. The fuel cell separator according to claim 11, wherein the connection channels are formed also at positions between channel forming ridges of the plurality of channel forming ridges that are positioned at both ends and both ends of the passage bead.

14. A fuel cell stack comprising:
a fuel cell separator; and
a membrane electrode assembly,
wherein the fuel cell separator is formed by joining two metal separators together, the metal separators each having bead structure formed to protrude from one surface serving as a reaction surface; a reactant gas flow field as a passage of a reactant gas is formed on the one surface of the metal separator, the reactant gas being one of a fuel gas and an oxygen-containing gas; a reactant gas passage connected to the reactant gas flow field extends through the metal separators in a separator thickness direction; and the bead structure includes a passage bead formed around the reactant gas passage;
a cutout configured to connect the reactant gas flow field and the reactant gas passage is formed in the passage bead of one of the metal separators;
a channel forming ridge extending between the reactant gas passage and the reactant gas flow field is provided in the cutout, integrally with one of the metal separators;
connection channels configured to connect the reactant gas flow field and the reactant gas passage are formed on both sides of the channel forming ridge;
the passage bead of another of the metal separators includes a part extending in a direction intersecting with the channel forming ridge as viewed in the separator thickness direction; and
the fuel cell separator comprises a plurality of fuel cell separators, the membrane electrode assembly comprises a plurality of membrane electrode assemblies, and the fuel cell separators and the membrane electrode assemblies are stacked together alternately.
